(19) United States
(12) Patent Application Publication
(10) Pub. No.: US 2010/0329127 A1
(43) Pub. Date: Dec. 30, 2010

(54) NETWORK ENTITY SELF-GOVERNING COMMUNICATION TIMEOUT MANAGEMENT

(75) Inventor: Timothy J. Pirozzi, Rochester, NH (US)

Correspondence Address: SCHWEGMAN, LUNDBERG & WOESSNER, P.A., P.O. BOX 2938, MINNEAPOLIS, MN, 55402, US

(73) Assignee: Computer Associates Think, Inc., Islandia, NY (US)

(21) Appl. No.: 12/494,816

(22) Filed: Jun. 30, 2009

(51) Int. Cl. H04L 12/26

(52) U.S. Cl. 370/242; 370/252

(57) ABSTRACT

Various embodiments include one or more of systems, methods, and software for self-governance of network entity timeout periods in network management. Some embodiments include sending at least one message to a network entity, receiving a response, and measuring a period between the sending and receiving. Some such embodiments further include calculating a timeout period for the network entity as a function of the measured period between the sending and the receiving and storing the calculated timeout period for the network entity. The timeout period for the network entity is a period after the passage of which a network management system declares contact has been lost with the network entity.

### BACKGROUND INFORMATION

Network management systems typically include fault management processes to identify and isolate faults within networks under management. One mode of fault detection includes contacting devices under management over a network and measuring response time. If a response is not received within a specified timeout period, a fault is declared. However, response times are measured and compared against a single, statically, and manually set timeout period, regardless of the network device or process under management.

### SUMMARY

Various embodiments include one or more of systems, methods, and software for self-governance of network entity timeout periods in network management. Some embodiments include sending at least one message to a network entity, receiving a response, and measuring a period between the sending and receiving. Some such embodiments further include calculating a timeout period for the network entity as a function of the measured period between the sending and the receiving and storing the calculated timeout period for the network entity. The timeout period for the network entity is a period after the passage of which a network management system declares contact has been lost with the network entity.

### BRIEF DESCRIPTION OF THE DRAWINGS

FIG. 1 is a logical diagram of a system according to an example embodiment.

FIG. 2 illustrates a data structure according to an example embodiment.

FIG. 3 is a block flow diagram of a method according to an example embodiment.

FIG. 4 is a block flow diagram of a method according to an example embodiment.

FIG. 5 is a block diagram of a computing device according to an example embodiment.

### DETAILED DESCRIPTION

Fault management in network management systems, such as the SPECTRUM® system developed by CA, Inc. of Islandia, N.Y., typically have globally set and static timeout periods on Simple Network Management Protocol (SNMP) and Internet Control Message Protocol (ICMP) packet requests. When a request to a network entity, such as a router, server, gateway, firewall, or other networking system, device, or process, is not responded to within that static period from the time the request packet is sent, the network management system concludes that the network entity is not responding. Upon concluding that the network entity is not responding, network management systems typically initiate a process such as a contact loss or a fault isolation process. However, in many instances, the failure to receive a response from the network entity within the static period is not due to a loss of connectivity, but rather is due to one or more of slow network entity processing performance, network latency, and incorrect configuration of the static timeout period. Thus, contact loss and fault isolation process are often initiated when contact has not truly been lost, but instead is just received outside of the statically set timeout period. As a result, processing is performed by the network management system which consumes network bandwidth and network entity processing resources, all of which are commonly unnecessary and needlessly increase system and network latency.

Various embodiments herein include one or more of systems, methods, software, and data structures to dynamically identify and configure timeout periods in network management systems. Some such embodiments include measuring response times when testing connectivity with network entities, determining a timeout period based on the measured response times, and modifying the timeout period for one or more network entities based on the measured response times. These and other embodiments are described with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices. Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

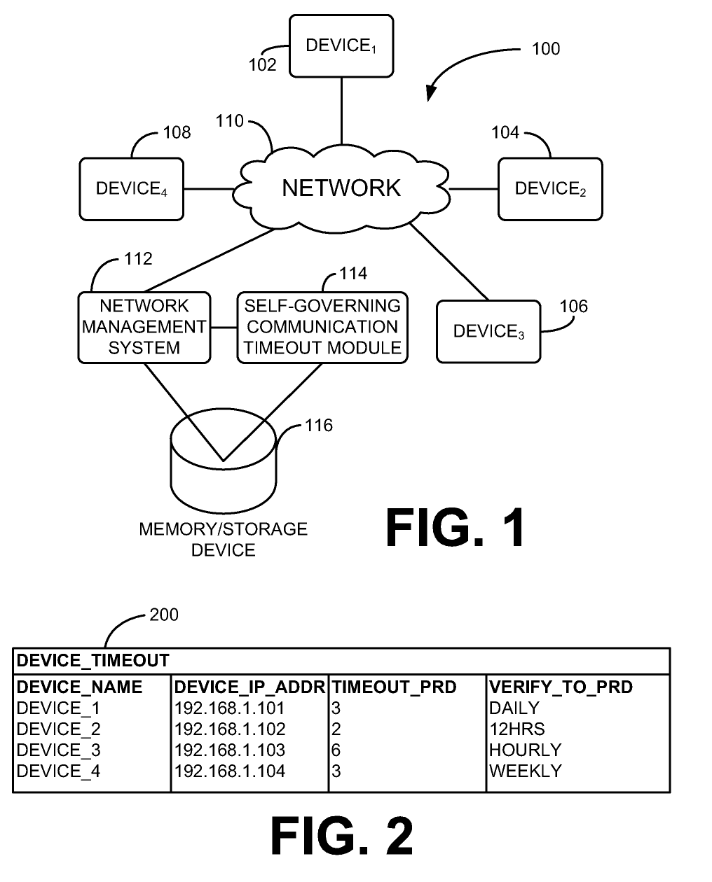

FIG. 1 is a logical diagram of a system 100 according to an example embodiment. The illustrated system 100 includes network entities, such as devices₁₋₄ 102, 104, 106, 108 that are communicatively connected to a network 110. The devices₁₋₄ 102, 104, 106, 108 may be physical or logical entities. Physical entities may include routers, hubs, server machines, computers, and other devices. Logical entities may include server process, database management systems, network management processes, and other processes that may execute on a physical entity. The network 110 may include one or more network types such as wired or wireless local area networks, system area networks, wide area networks, the Internet, and the like.

The system 100 also includes a network management system 112 that includes or is augmented with a self-governing communication timeout module 114. The self-governing communication timeout module 114 in some embodiments is operable to communicate with the devices₁₋₄ 102, 104, 106, 108 to verify that the devices are still contactable over the network 110, to measure response time of the devices₁₋₄ 102, 104, 106, 108, and to calculate and set a timeout period for the devices₁₋₄ 102, 104, 106, 108. The response time of each device may be measured through sending of SNMP or ICMP packet requests, such as a PING which measure a round-trip period between the sending of the PING by the self-governing communication timeout module 114 to receipt of a response from the target network entity, such as one of the devices₁₋₄ 102, 104, 106, 108. The timeout period for a device may be calculated in any number of ways, such as by measuring a response period to a single PING and applying a formula to that period, such as multiply the measured period by 1.25 to add an additional 25 percent to the measured response period and using that period as the timeout period. The timeout period may then be stored, such as in a memory or storage device 116 that is accessed by the network management system 112 when determining when network 110 communication with a network entity, such as one of the devices₁₋₄ 102, 104, 106, 108, has been lost.

FIG. 2 illustrates a data structure 200 according to an example embodiment. The data structure 200 is an example of a data structure that may be maintained by the self-governing communication timeout module 114 of FIG. 1 and utilized by the network management system 112. The data structure 200 may be stored in the memory or storage device 116, also of FIG. 1.

The data structure 200 is an example of a data structure that is used to hold timeout period configuration data. Although the data structure is illustrated as a database table, the data structure may be stored in other forms, such as files or data within another file. Further, the held in the data structure may vary depending on the requirements of the specific embodiment. As illustrated in FIG. 2, the data structure includes a device name, a device IP address, a timeout period, and a verify timeout period. The device name is simply a name that may be given to a device to aid an administrator in quickly identifying the device of the particular data row. In other embodiments, the device name may be a name of the device that may be used to address the device over a network. The device IP address is a network address of the respective device. The timeout period is a period which a network management system is configured to wait until declaring that communication has been lost with the device. The verify time out period is the periodic interval at which a self-governing communication timeout module verifies the timeout period according to one or more of the methods herein. Note that although the discussion of FIG. 2 is with regard to devices, data regarding other network entity types, such as processes, may also or alternatively maintained in the data structure 200.

Although the various embodiments herein are described with regard to setting network entity specific timeout periods, other embodiments may include a single, globally set timeout period that is determined according to the methods described herein. For example, if a particular network management system includes a single, global timeout setting for network entities, or a limited number of timeout settings, such a setting or settings may be dynamically calculated by measuring roundtrip times between the sending and receiving of messages to such one or more network entities, calculating the timeout period, and then storing it.

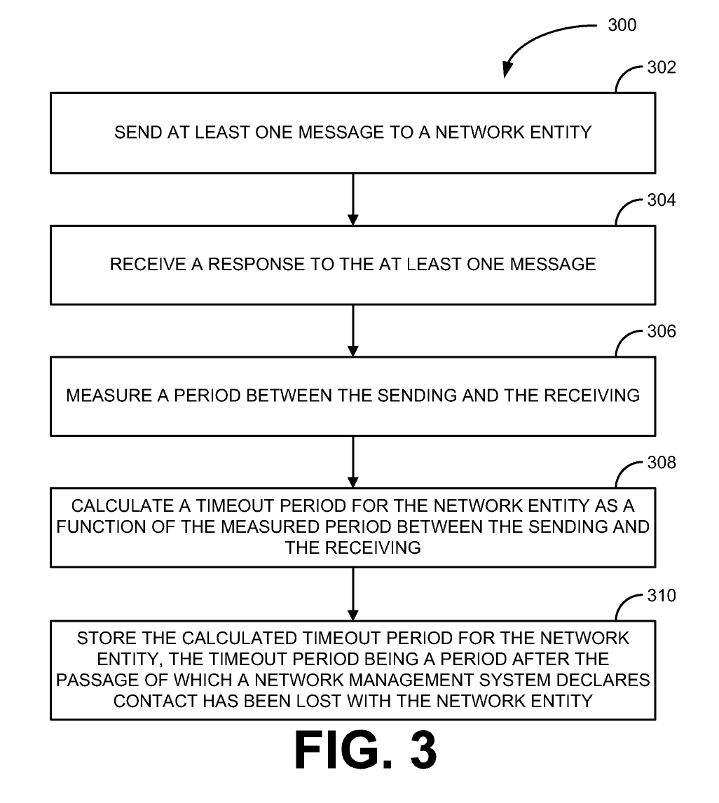

FIG. 3 is a block flow diagram of a method 300 according to an example embodiment. The method 300 is an example of a method that may be performed by the self-governing communication timeout module 114 of FIG. 1. Note however that the method 300, and that other methods described herein, may be performed within a network management system, a stand-alone process or application that might update timeout period configurations of network entities wherever such configurations are stored in a particular embodiment, such as in, in association with, or in a location accessible by a network entity.

The method 300 includes sending 302, over a network via a network interface device, at least one message to a network entity and receiving 304, over the network via the network interface device, a response to the at least one message. The method 300 further includes measuring 306 a period between the sending and receiving. The measuring 306 of the period between the sending and receiving may be performed, in various embodiments, through an explicit timing process or may be performed automatically by an SNMP or ICMP method called to send and receive the at least one message. Such a method may include a PING.

The method 300, following the measuring 306, includes calculating 308 a timeout period for the network entity as a function of the measured period between the sending and the receiving and storing 310 the calculated timeout period for the network entity in a data storage device. The timeout period for the network entity in typical embodiments being a period after the passage of which a network management system declares contact has been lost with the network entity.

In some embodiments, sending 302 the at least one message to the network entity includes sending a configurable number messages to the network entity. The configurable number may be a configuration setting stored in a location accessible a network management system, a self-governing communication timeout module, or other process performing the method 300. The configurable number of messages, in some embodiments, is three messages. In other embodiments, the configurable number of messages is one, two, four, five, or other number of messages as configured within a particular system. The number of messages is configured in some embodiments to be a number selected by an administrator or automated configuration process that is a large enough sample size to give an accurate representation of network entity response time to the sent 302 messages. In some embodiments, the number of messages may be sent 302 in a serial manner back to back. In other embodiments, the number of messages may be sent 302 at intervals, such as one every minute, every five minutes, every hour, or other interval.

In some embodiments, the receiving 304 the response to the at least one message includes receiving a response to each of the messages sent 302. Further, measuring 306 the period between the sending 302 and receiving 304 includes measuring 306 a period between the sending 302 and receiving 304 of each of the configurable number of messages sent responses received. Calculating 308 the timeout period for the network entity may include calculating the timeout period as a function of the measured periods of the number of messages sent 302 and received.

In some embodiments, calculating 308 the timeout period as a function of the measured periods includes calculating the timeout period as percentage greater than an average of the measured periods. In another embodiment, the timeout period is calculated based on an average of the measured periods plus an additional period. In further embodiments, the timeout period is calculated based on a largest of the measured periods. In these and other embodiments, the timeout period may be calculated 308 in view of a minimum and maximum timeout periods. For example, if the calculated 308 timeout period is less than the minimum timeout period, the minimum timeout period will be stored 310. Similarly, if the calculated 308 timeout period is greater than the maximum timeout period, the maximum timeout period will be stored 310.

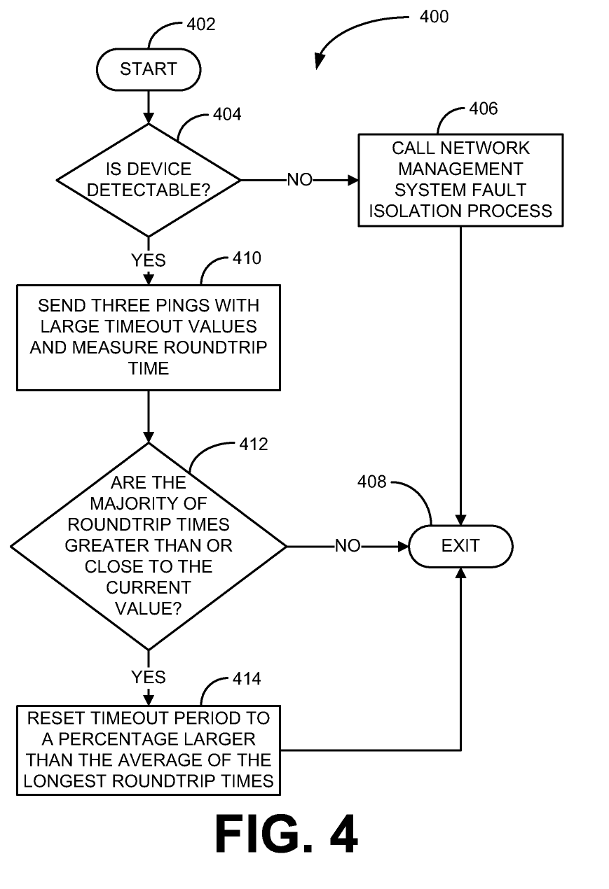

FIG. 4 is a block flow diagram of a method 400 according to an example embodiment. The method 400 is another example of a method that may be performed to determine a timeout period for network entities. The method 400 starts at 402 and determines 404 if a network entity, such as a device, is detectable. If the network entity is not detectable, the method 400 includes calling 406 a network management system fault isolation process and the method 400 then exits. However, if the network entity is detectable, such as via a PING or other network message, the method 400 then sends 410 three PINGs with large timeout values and the roundtrip time is measured. The method 400 then determines 412 if the majority of the roundtrip times are greater than or close to a current timeout value for the respective network entity. If the majority of the roundtrip times are not greater than or close to a current timeout value for the respective network entity, the current timeout value is maintained and the method 400 exits 408. When the majority of the roundtrip times are greater than or close to a current timeout value for the respective network entity, the method resets 414 the timeout period to a percentage larger than the average of the longest roundtrip times and then the method 400 exits.

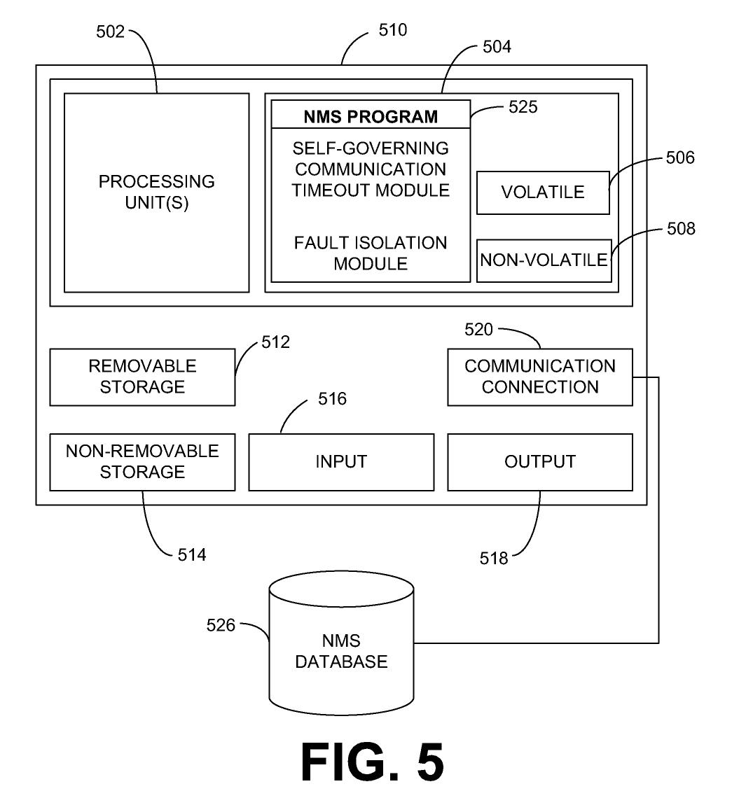

FIG. 5 is a block diagram of a computing device according to an example embodiment. The computing device is an example of a computing device upon which a network management system program 525 including a self-governing communication timeout module may execute. In one embodiment, multiple such computer systems are utilized in a distributed network to implement multiple components in a transaction-based environment. An object oriented, service oriented, or other architecture may be used to implement such functions and communicate between the multiple systems and components. One example computing device in the form of a computer 510, may include one or more processing units 502, memory 504, removable storage 512, and non-removable storage 514. Memory 504 may include volatile memory 506 and non-volatile memory 508. Computer 510 may include—or have access to a computing environment that includes—a variety of computer-readable media, such as volatile memory 506 and non-volatile memory 508, removable storage 512, and non-removable storage 514. Computer storage includes random access memory (RAM), read only memory (ROM), erasable programmable read-only memory (EPROM) & electrically erasable programmable read-only memory (EEPROM), flash memory, or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer storage may also include a database, such as a network management system database 526 that may store configuration settings, in particular network entity timeout settings.

Computer 510 may include or have access to a computing environment that includes input 516, output 518, and a communication connection 520. The computer 510 operates in a networked environment, such as is illustrated in FIG. 1, using a communication connection to connect to one or more remote network entities. The communication connection may include a Local Area Network (LAN), a Wide Area Network (WAN), a System Area Network (SAN), the Internet, or other networks. The communication connection may include a connection to such network types using at least one of a wired or wireless network interface device.

Computer-readable instructions stored on a computer-readable medium are executable by the one or more processing units 502 of the computer 510. A hard drive, CD-ROM, and RAM are some examples of articles including a computer-readable medium. For example, the network management system program 525 including a self-governing communication timeout module may be included on a CD-ROM, in the memory 504, or other memory or storage device. The computer-readable instructions allow computer 510 to perform one or more of the methods described herein and may include further instructions to cause the computer 510 to provide network management system functionality.

Another embodiment is in the form of a system. The system in such embodiments includes at least one processor, at least one memory device, and a network interface device operatively coupled within the system. The system further includes an instruction set, held in the at least one memory device, defining a self-governing communication timeout module that is executable by the at least one processor. The self-governing communication timeout module in such embodiments is executable by the at least one processor to verify that communication with a network entity is possible via the network interface device and measure communication response time with the network entity. The self-governing communication timeout module is further executable by the at least one processor to calculate and store, on the at least one memory device, a timeout period for the network entity based on the measured communication response time with the network entity.

In the foregoing Detailed Description, various features are grouped together in a single embodiment to streamline the disclosure. This method of disclosure is not to be interpreted as reflecting an intention that the claimed embodiments of the inventive subject matter require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method comprising:
sending, over a network via a network interface device, at least one message to a network entity;
receiving, over the network via the network interface device, a response to the at least one message;
measuring a period between the sending and the receiving;
calculating a timeout period for the network entity as a function of the measured period between the sending and the receiving; and
storing the calculated timeout period for the network entity in a data storage device, the timeout period for the network entity being a period after the passage of which a network management system declares contact has been lost with the network entity.

2. The method of claim 1, wherein:
the sending at least one message to the network entity includes sending a configurable number messages to the network entity;
the receiving the response to the at least one message includes receiving a response to each of the messages;
the measuring a period between the sending and receiving includes measuring a period between the sending and receiving of each of the configurable number of messages sent and responses received; and
calculating the timeout period for the network entity includes calculating the timeout period as a function of the measured periods.

3. The method of claim 2, wherein calculating the timeout period as a function of the measured periods includes calculating the timeout period as percentage greater than an average of the measured periods.

4. The method of claim 2, wherein calculating the timeout period as a function of the measured periods includes calculating the timeout period as percentage greater than the largest of the measured periods.

5. The method of claim 1, wherein the method is repeated on a recurring periodic basis.

6. The method of claim 1, wherein upon the network management system declaring contact has been lost with the network entity, calling a fault isolation process of the network management system.

7. The method of claim 1, wherein calculating the timeout period for the network entity includes:
determining when a calculated timeout period is less than a minimum timeout period; and
adjusting the calculated timeout period to the minimum timeout period.

8. A system comprising:
at least one processor, at least one memory device, and a network interface device operatively coupled within the system;
an instruction set held in the at least one memory device, the instruction set defining a self-governing communication timeout module, the self-governing communication timeout module executable by the at least one processor to:
verify that communication with a network entity is possible via the network interface device;
measure communication response time with the network entity; and
calculate, on the at least one processor, and store, on the at least one memory device, a timeout period for the network entity based on the measured communication response time with the network entity, the timeout period for the network entity being a period after the passage of which a network management system declares contact has been lost with the network entity.

9. The system of claim 8, wherein the self-governing communication timeout module, when calculating the timeout period for the network entity, is executable by the at least one processor to:
determine a calculated timeout period is less than a minimum timeout period; and
adjust the calculated timeout period to the minimum timeout period.

10. The system of claim 8, wherein the self-governing communication timeout module performs the verifying, measuring, calculating, and storing for each of a plurality of network entities under management of the network management system.

11. The system of claim 8, wherein the self-governing communication timeout module is further executable by the at least one processor upon receipt of a command with regard to a particular network entity.

12. The system of claim 11, wherein the command is received from the network management system.

13. The system of claim 8, wherein the verifying is performed on a periodic basis.

14. The system of claim 8, wherein the storing of the timeout period includes storing a value representative of the timeout period and the at least one memory device to which the timeout period is stored is accessible to the network management system.

15. A computer-readable storage medium, with instructions stored thereon, which when executed by at least one processor, cause a computer to:
send, over a network via a network interface device, at least one message to a network entity;
receive, over the network via the network interface device, a response to the at least one message;
measure a period between the sending and the receiving;
calculate a timeout period for the network entity as a function of the measured period between the sending and the receiving; and
store the calculated timeout period for the network entity in a data storage device, the timeout period for the network entity being a period after the passage of which a network management system declares contact has been lost with the network entity.

16. The computer-readable storage medium of claim 15, wherein:
the sending at least one message to the network entity includes sending three messages to the network entity;
the receiving the response to the at least one message includes receiving a response to each of the three messages;
the measuring a period between the sending and receiving includes measuring a period between the sending and receiving of each of the three messages sent and the three responses received; and
calculating the timeout period for the network entity includes calculating the timeout period as a function of the three measured periods.

17. The computer-readable storage medium of claim 16, wherein calculating the timeout period as a function of the three measured periods includes calculating the timeout period as percentage greater than an average of the three measured periods.

18. The computer-readable storage medium of claim 16, wherein calculating the timeout period as a function of the three measured periods includes calculating the timeout period as percentage greater than the largest of the three measured periods.

19. The computer-readable storage medium of claim 15, wherein upon the network management system declaring contact has been lost with the network entity, calling a fault isolation process of the network management system.

20. The computer-readable storage medium of claim 15, wherein calculating the timeout period for the network entity includes:
determining when a calculated timeout period is less than a minimum timeout period; and
adjusting the calculated timeout period to the minimum timeout period.
